(19) United States
(12) Patent Application Publication
(10) Pub. No.: US 2014/0369883 A1
(43) Pub. Date: Dec. 18, 2014

(54) COPPER ALLOY AND METHOD OF PRODUCING SAME

(71) Applicants: Takefumi ITO, Chiyoda-ku (JP); Toshikazu KAWAHATA, Sagamihara-shi (JP); Yumiko IWASHITA, Sagamihara-shi (JP); Toshihiro KURITA, Sagamihara-shi (JP); Takayuki NAGAI, Chiyoda-ku (JP)

(72) Inventors: Takefumi ITO, Chiyoda-ku (JP); Toshikazu KAWAHATA, Sagamihara-shi (JP); Yumiko IWASHITA, Sagamihara-shi (JP); Toshihiro KURITA, Sagamihara-shi (JP); Takayuki NAGAI, Chiyoda-ku (JP)

(73) Assignees: MITSUBISHI ELECTRIC CORPORATION, CHIYODA-KU (JP); MITSUBISHI ELECTRIC METECS CO., LTD., SAGAMIHARA-SHI (JP)

(21) Appl. No.: 14/473,599

(22) Filed: Aug. 29, 2014

Related U.S. Application Data
(62) Division of application No. 11/758,830, filed on Jun. 6, 2007.

(30) Foreign Application Priority Data
Aug. 30, 2006 (JP) 2006-233962

(51) Int. Cl. H01B 1/02; C22C 9/06

(52) U.S. Cl. CPC H01B 1/026; C22C 9/06
USPC 420/476; 420/481; 420/484; 420/477; 420/490

(57) ABSTRACT

To obtain a copper alloy having a tensile strength of 700 N/mm² or more and a conductivity of 60% IACS or more, a copper alloy of the present invention comprises from 0.8 mass % to 1.8 mass % of Co, from 0.16 mass % to 0.6 mass % of Si, and the balance of Cu and unavoidable impurities, in which a mass ratio of Co to Si (Co/Si) is between 3.0 and 5.0; a size of inclusions to be precipitated in the copper alloy is 2 μm or less; and a total volume of the inclusions having a size of between 0.05 μm and 2 μm in the copper alloy is 0.5 vol % or less.

### BACKGROUND OF THE INVENTION

1. Field of the Invention

The present invention relates to a copper alloy and to a method of producing same. In particular, the present invention relates to a copper alloy used for electronic components and to a method of producing same.

2. Description of the Related Art

In lead frames having integrated circuits (IC) mounted thereon, connector terminals to be used in electronic devices, or the like, reductions in thickness of the lead frame and increases in the number of pins and reductions in terminal pitch have progressed with the miniaturization and multifunctionalization of the devices to be used and with increases in packaging surface density. For these reasons, there is an increasing demand for reliable connections in packaging of electronic components.

That is, a metal material used for such electronic components must have further improved strength because miniaturization of electronic components leads to reductions in thickness. Further, the metal material must have further improved conductivity because increases in the number of pins and reductions in pitch lead to reductions in sectional area.

As a metal material used for electronic components having high strength and high conductivity, an alloy material containing beryllium (Be) added to copper (Cu) is conventionally known. Among these alloy materials, there are some having a high tensile strength of 800 N/mm² or more and a high conductivity of 50% IACS (International Annealed Copper Standard) or more.

However, in consideration of recent environmental issues, use of an alloy material containing Be is now being avoided. Thus, copper alloys replacing such alloy materials have been attracting attention.

Of the copper alloys, a Cu—Co—Si-based alloy is known to be a precipitation hardened alloy in which a fine Co₂Si intermetallic compound is dispersed and precipitated in Cu and serves as a barrier against transformation to provide further improved strength and conductivity. It is reported that strength and conductivity can be further improved by adjusting addition amounts of Co and Si and further adding trace amounts of additives.

An example of the conventional Cu—Co—Si-based alloy is a copper alloy used for lead frames containing from 0.4 wt % to 1.6 wt % of Co, from 0.1 wt % to 0.5 wt % of Si, the balance of Cu and unavoidable impurities and further containing from 0.05 wt % to 1.0 wt % of Zn and from 0.0005 wt % to 0.1 wt % of at least one element selected from the group consisting of Ca, Y, rare earth elements, Ti, Zr, Hf, V, and Nb (see JP 2-277735 A, for example).

Another example thereof is a copper alloy used for electronic and electric components containing from 0.1 wt % to 3.0 wt % of Co, from 0.3 wt % to 1.0 wt % of Si, from 0.3 wt % to 1.0 wt % of Zn, from 0.005 wt % to 0.1 wt % of Mn, from 0.005 wt % to 0.1 wt % of P, the balance of Cu and unavoidable impurities, containing a compound of Co and Si and a compound of Co and P in a parent phase, having an average grain size of the parent phase of 20 μm or less, and having an aspect ratio in a thickness direction with respect to a rolling direction of between 1 and 3 (see JP 9-20943 A, for example).

However, in conventional copper alloys, addition amounts of Co, Si, and other elements and a Co/Si ratio may not be optimized and the copper alloy may not have an appropriate structure. Thus, no conventional copper alloy has excellent strength and conductivity. For example, studies have been conducted on the composition of the copper alloy in JP 2-277735 A and JP 9-20943 A, but no studies have been conducted on inclusions to be precipitated in the copper alloy. Thus, copper alloys have problems in that they have no appropriate structure and either strength or conductivity for example, is not sufficient. As a result, conventional copper alloys cannot satisfy a tensile strength of 700 N/mm² or more and a conductivity of 60% IACS or more at the same time.

### SUMMARY OF THE INVENTION

The present invention has been made in view of solving the problems as described above, and an object of the present invention is to provide a copper alloy having excellent strength and conductivity, in particular, a copper alloy having a tensile strength of 700 N/mm² or more and a conductivity of 60% IACS or more.

Another object of the present invention is to provide a method of producing a copper alloy having the properties as described above.

The inventors of the present invention have conducted extensive studies for solving the problems as described above, and have conceived that the composition of a copper alloy and the size and total amounts of inclusions to be precipitated in the copper alloy are optimized to optimize a structure of the copper alloy. Thus, the inventors have completed the present invention.

That is, the present invention provides a copper alloy comprising from 0.8 mass % to 1.8 mass % of Co, from 0.16 mass % to 0.6 mass % of Si, and the balance of Cu and unavoidable impurities, in which a mass ratio of Co to Si (Co/Si) is between 3.0 and 5.0; size of inclusions to be precipitated in the copper alloy is 2 μm or less; and total volume of the inclusions having a size of between 0.05 μm and 2 μm in the copper alloy is 0.5 vol % or less.

Further, the present invention provides a method of producing a copper alloy including the steps of: (a) melting a copper alloy raw material including from 0.8 mass % to 1.8 mass % of Co, from 0.16 mass % to 0.6 mass % of Si, and the balance of Cu and unavoidable impurities and having a mass ratio of Co to Si (Co/Si) is between 3.0 and 5.0 to form an ingot, and rolling the ingot; (b) carrying out solution treatment involving heating the rolled material to between 700° C. and 1,000° C. and quenching; (c) carrying out aging treatment by heating an alloy material subjected to the solution treatment at between 400° C. and 600° C. for 2 hours to 8 hours; (d) cooling the alloy material subjected to the aging treatment to at least 380° C. at a cooling rate of between 10° C./h and 50° C./h; and (e) finishing the cooled alloy material by cold rolling.

According to the present invention, an optimum precipitated amount of a Co₂Si compound may be included in the copper alloy, and contents of Co and Si elements remained in a solid solution state may be reduced. Thus, a copper alloy having excellent strength and conductivity, in particular, a copper alloy having a tensile strength of 700 N/mm² or more and a conductivity of 60% IACS or more can be provided.

### BRIEF DESCRIPTION OF THE DRAWINGS

In the accompanying drawings:

FIG. 1 is a flow chart illustrating a method of producing a copper alloy of the present invention; and

FIG. 2 is a graph showing a relationship between tensile strength and conductivity of copper alloys obtained in Examples 1 and 2 and Comparative Examples 1 and 2.

### DETAILED DESCRIPTION OF THE INVENTION

### Embodiment 1

### Copper Alloy

A copper alloy of the present invention is comprised of from 0.8 mass % to 1.8 mass % of Co, from 0.16 mass % to 0.6 mass % of Si, and the balance of Cu and unavoidable impurities. In a case where Co content is less than 0.8 mass % or Si content is less than 0.16 mass %, a sufficient amount of a Co₂Si compound is not formed and desired strength and conductivity cannot be obtained. In contrast, in the case where the Co content is more than 1.8 mass % or the Si content is more than 0.6 mass %, an excess amount of a Co—Si compound phase or a Cu—Co—Si alloy phase is precipitated and desired strength and conductivity cannot be obtained.

Further, a mass ratio of Co to Si (Co/Si) is within a range of between 3.0 and 5.0. In the case where the mass ratio is less than 3.0 or more than 5.0, an excess amount of a Co—Si compound phase or a Cu—Co—Si alloy phase excluding the Co₂Si compound is precipitated and desired strength and conductivity cannot be obtained.

The unavoidable impurities in the present invention refer to substances included in a general base metal or impurities mixed into the copper alloy during production, and examples thereof include As, Sb, Bi, Pb, S, Fe, O₂, and H₂. Of these, from the viewpoint of improving plating adhesion and soldering properties, the copper alloy of the present invention preferably has an O₂ content of 10 ppm or less and an H₂ content of 1 ppm or less. In cases where O₂ content is more than 10 ppm, the plating adhesion and soldering properties may degrade. In cases where H₂ content is more than 1 ppm, the plating adhesion and soldering properties may degrade.

Further, inclusions are precipitated in the copper alloy of the present invention, and size of the inclusions is 2 μm or less. In cases where the size of the inclusions is more than 2 μm, desired strength cannot be obtained and the plating adhesion degrades.

The inclusions in the present invention refer to bulky precipitated particles formed during production of the copper alloy. To be specific, inclusions refer to particles of oxides formed through reaction with the atmosphere or particles of undesired Co—Si compound phases or Cu—Co—Si alloy phases excluding the fine Co₂Si compound.

The size of the inclusions refers to diameter of the inclusions if the inclusions are spherical and refers to a shorter diameter or shorter side of the inclusions if the inclusions are elliptical or rectangular.

In the copper alloy of the present invention, total volume of the inclusions having a size of between 0.05 μm and 2 μm in the copper alloy is 0.5 vol % or less. In the case where the total volume of the inclusions is more than 0.5 vol %, desired strength cannot be obtained and the plating adhesion degrades.

Volume ratio of the inclusions in the copper alloy of the present invention can be determined by polishing a section of the copper alloy of the present invention and observing the polished surface with a scanning electron microscope. The volume ratio of the inclusions can be determined by specifying an observation region of this case as a region at a predetermined depth (for example, about 1 μm) or more from an uppermost surface of a sample, integrating the total area of the inclusions in the observation region through image processing, and determining the total area by the observation region. To be specific, five arbitrary observation regions of about 100×100 μm are observed, and an average value of area ratios of the inclusions in each observation region is referred to as the volume ratio of the inclusions.

The copper alloy of the present invention may contain Zn from the viewpoint of improving plating adhesion. Zn has an effect of suppressing interfacial peeling due to change over time after Sn (tin) plating and Sn alloy plating. Zn content is preferably from 0.1 mass % to 1.0 mass %. Zn content within the above range can improve the plating adhesion without degrading the strength and conductivity of the copper alloy. In cases where the Zn content is less than 0.1 mass %, the effects of improving the plating adhesion through Zn addition may not be obtained. In contrast, in cases where the Zn content is more than 1.0 mass %, the conductivity may degrade.

The copper alloy of the present invention may contain one or more elements selected from the group consisting of Fe, Ni, P, Sn, Mg, Zr, Cr, and Mn from the viewpoint of further improving the strength. Of those, Fe and Ni are more preferred because the elements each have an effect of improving bending workability through formation of fine crystal grains. Content of the elements is preferably from 0.01 mass % to 0.2 mass % in total. In cases where the content of the elements is less than 0.01 mass %, the effects of improving strength through addition of the elements may not be obtained. In contrast, in cases where the content of the elements is more than 0.2 mass %, the conductivity may degrade.

### (Method of Producing Copper Alloy)

In a conventional method of producing a copper alloy, an ingot obtained by melting and casting a copper alloy raw material is subjected to hot rolling, then to cold rolling, and the like, thereby forming lattice defects in the copper alloy.

For example, in a method of producing a copper alloy in JP 2-277735 A, a copper alloy raw material is melted and cast in a mold to obtain an ingot having desired dimensions. The ingot is subjected to hot rolling at 950° C. and then water cooled immediately. Then, a surface of the hot rolled plate is subjected to milling, to cold rolling to a desired thickness, and then the resultant is subjected to heat treatment at 500° C. for 1 hour, subjected to rolling to a desired thickness again, and subjected to stress relief annealing at 300° C. for 1 hour.

In a method of producing a copper alloy in JP 9-20943 A, a copper alloy raw material is melted and cast to obtain an ingot having desired dimensions. Then, the ingot is maintained at 980° C. for 3 hours, subjected to hot rolling, and subjected to milling or pickling and buffing, to thereby obtain desired dimensions. Next, the resultant is subjected to cold rolling at 85% or more, annealing at between 450° C. and 480° C. for 5 minutes to 30 minutes, cold rolling at 30% or less, and aging treatment at between 450° C. and 500° C. for 30 minutes to 120 minutes.

Meanwhile, the inventors of the present invention have conducted extensive studies on a method of producing a copper alloy having the properties as described above. As a result, the inventors of the present invention have found that introduction of lattice defects through cold rolling or the like after hot rolling is not important and cooling of the copper alloy subjected to the aging treatment to at least 380° C. at a cooling rate of between 10° C./h and 50° C./h is important for improving the strength and conductivity of the copper alloy.

To be more specific, the inventors of the present invention have found that sufficient lattice defects are introduced into the copper alloy through quenching after solution treatment, and additional introduction of strain through cold rolling or the like is not needed. Meanwhile, through trials, the inventors of the present invention have found that control of the cooling rate at between 10° C./h and 50° C./h after the aging treatment without cold rolling or the like provides effects of precipitating a sufficient amount of the Co₂Si compound and preventing residual strain remaining in the copper alloy.

That is, the method of producing a copper alloy of the present invention includes the steps of: (a) melting a copper alloy raw material including from 0.8 mass % to 1.8 mass % of Co, from 0.16 mass % to 0.6 mass % of Si, and the balance of Cu and unavoidable impurities and having a mass ratio of Co to Si (Co/Si) of between 3.0 and 5.0 to form an ingot, and rolling the ingot; (b) carrying out solution treatment involving heating the rolled material to between 700° C. and 1,000° C. and quenching; (c) carrying out aging treatment by heating an alloy material subjected to the solution treatment at between 400° C. and 600° C. for 2 hours to 8 hours; (d) cooling the alloy material subjected to the aging treatment to at least 380° C. at a cooling rate of between 10° C./h and 50° C./h; and (e) finishing the cooled alloy material by cold rolling.

In step (a), the copper alloy raw material may further contain from 0.1 mass % to 1.0 mass % of Zn from the viewpoint of improving the plating adhesion. The reasons for the mixing amount are described above.

The copper alloy material may further contain from 0.01 mass % to 0.2 mass % of one or more elements selected from the group consisting of Fe, Ni, P, Sn, Mg, Zr, Cr, and Mn in total from the viewpoint of further improving the strength. The reasons for the mixing amount are described above.

The copper alloy raw material may have an O₂ content of 10 ppm or less and an H₂ content of 1 ppm or less from the viewpoint of improving the plating adhesion and soldering properties. The reasons for the contents are described above. A method of reducing the O₂ and H₂ contents in the copper alloy raw material is not particularly limited, and a conventional method may be employed. An example of the method includes: methods involving using a deoxidizing agent such as calcium boride; and methods involving bubbling treatment by using argon gas, nitrogen gas, or the like.

The method of melting the copper alloy raw material is not particularly limited. The method may involve heating the copper alloy raw material to a melting temperature or higher by using a conventional device such as a high frequency melting furnace. The method of casting or rolling is not particularly limited, and the method may be carried out according to conventional methods.

Note that during step (a), milling may be conducted after the ingot is formed from the viewpoint of removing scales of the ingot. Further, after step (a), annealing may be conducted from the viewpoints of softening the alloy to improve workability, and the like. Methods of milling and annealing are not particularly limited, and the methods may be carried out according to conventional methods.

The solution treatment in step (b) involves heating of the rolled material to between 700° C. and 1,000° C. and quenching the resultant. Heating time is preferably between 1 minute and 60 minutes. A heating temperature and heating time within the above ranges allow favorable formation of a solid solution of alloy elements. Methods of heating and quenching are not particularly limited, and the methods may be carried out according to conventional methods.

The aging treatment in step (c) involves heating of the alloy raw material subjected to the solution treatment at between 400° C. and 600° C. for 2 hours or more and 8 hours or less. A heating temperature and heating time within the above ranges can provide a fine Co₂Si compound in a precipitated state. Heating methods are not particularly limited, and the method may be carried out according to conventional methods.

Step (d) involves cooling of the alloy raw material subjected to the aging treatment to at least 380° C. at a cooling rate of between 10° C./h and 50° C./h.

A cooling rate within the above range allows sufficient amount of the Co₂Si compound to be precipitated and prevents residual strain remaining in the copper alloy. In cases where the cooling rate is less than 10° C./h, the Co₂Si compound increases in size and desired strength cannot be obtained. In contrast, in cases where the cooling rate is more than 50° C./h, residual strain remains in the copper alloy and the amount of the Co₂Si compound that precipitates are reduced due to the strain, so the Co and Si remain as they are in a solid solution state. Thus, desired strength and conductivity cannot be obtained.

In cases where the cooling temperature is higher than 380° C., an appropriate structure of the copper alloy cannot be obtained and desired strength and conductivity cannot be obtained. Note that after the cooling temperature reaches 380° C., since the structure of the copper alloy does not change drastically through the cooling process thereafter, the lower limit of the cooling temperature is not particularly limited. However, from the viewpoint of stably obtaining a copper alloy having an appropriate structure, the alloy raw material is preferably cooled to 350° C. at a cooling rate of between 10° C./h and 50° C./h.

Step (e) involves cold rolling of the alloy raw material for finishing into a copper alloy having a desired size. The methods of cold rolling are not particularly limited, and the method may be carried out according to conventional methods. After step (e), low temperature annealing may be conducted from the viewpoint of stress relieving of the copper alloy. The method of low temperature annealing is not particularly limited, and the method may be carried out according to conventional methods.

The copper alloy to be obtained by the production method as described above is capable of suppressing increase in size of the Co₂Si compound to be precipitated in the copper alloy and precipitating a sufficient amount of the fine Co₂Si compound, and thus has excellent strength and conductivity.

### EXAMPLES

Hereinafter, the present invention will be described specifically with reference to the examples, but the present invention is not limited to the following examples.

The following properties of copper alloys obtained in the Examples and Comparative Examples were evaluated through the following procedures.

### (1) Tensile Strength

The tensile strength was evaluated at room temperature in accordance with JIS Z2241.

### (2) Conductivity

The conductivity was evaluated at room temperature in accordance with JIS H0505.

### (3) Plating Adhesion

The plating adhesion was evaluated by: subjecting a copper alloy to Sn electroplating to a thickness of 3 μm; heating the copper alloy at 105° C. for 500 hours (500 hours and 1,000 hours in Example 4 alone); conducting a bending and unbending test at 180′; and visually observing a sample surface. In the evaluation: a sample having a plated film without any damage is indicated by ◯; a sample having an unpeeled plated film with damage observed is indicated by Δ; and a sample having a peeled plated film is indicated by x.

### (4) Bending Workability

The bending workability was evaluated in accordance with JIS Z2248 by conducting a V-bending test at 90° at a bending radius of 0.3 mm and observing a bent end surface with an optical microscope. In the evaluation: a sample having no wrinkles is indicated by A; a sample having small wrinkles is indicated by B; a sample having large wrinkles is indicated by C; a sample having small cracks is indicated by D; and a sample having large cracks is indicated by E.

### (5) Soldering Property

The soldering property was evaluated by: applying flux to a copper alloy subjected to pickling; immersing the resultant in solder consisting of 60 mass % of Sn and 40 mass % of Pb at 235° C. for 5 seconds; and visually observing a sample surface after pulling the sample out. In the evaluation: a sample having uniform and wet solder on a surface is indicated by ◯; a sample having wet but non-uniform solder with unevenness on a surface is indicated by Δ; and a sample having solder with a non-wet part on a surface is indicated by x.

### Example 1

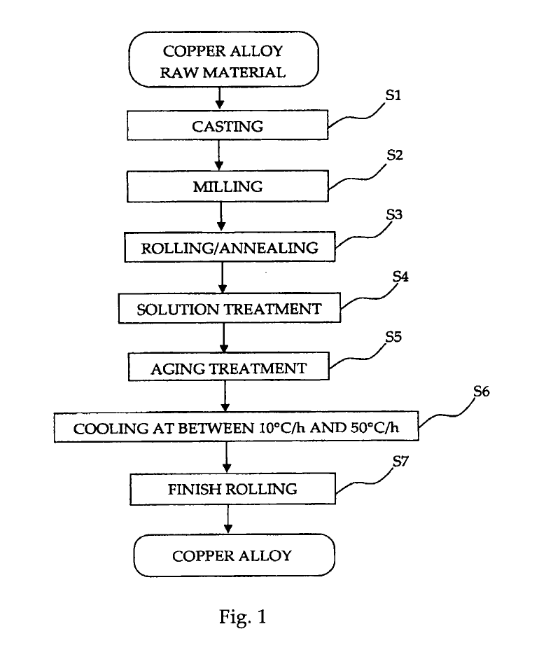

In Example 1, copper alloys (Products 1 to 3 of the present invention) each containing Cu, Co, Si, and unavoidable impurities in a predetermined ratio were produced following the flow chart shown in FIG. 1. Note that a Cu amount was clarified, but the Cu amount can obviously be estimated from amounts of other components shown. Hereinafter, detailed description will be given of a method of producing a copper alloy by using the flow chart.

First, copper alloy raw materials (such as Cu, Co, and Si) satisfying a composition ratio shown in Table 1 were prepared. The copper alloy raw materials were melted in a high frequency melting furnace and cast into a plate-like ingot having a thickness of 10 mm (step S1).

Next, milling was conducted for removing scale on an ingot surface (step S2).

Then, the ingot was subjected to rolling at room temperature, annealing at 800° C., and rolling at room temperature again, to thereby obtain a sheet having a thickness of 0.38 mm (step S3).

Then, the sheet was heated at 950° C. for 2 minutes and cooled in water for solution treatment (step S4).

The sheet was heated at 500° C. for 4 hours for aging treatment (step S5).

Then, the sheet was cooled to 380° C. at a cooling rate (to be specific, at the respective cooling rates shown in Table 1) of between 10° C./h and 50° C./h (step S6).

Then, the sheet was subjected to cold rolling (finish rolling), to thereby obtain a copper alloy having a thickness of 0.3 mm (step S7).

Note that the final cold working rate in Example 1 was 21%.

### Example 2

In Example 2, copper alloys (Products 4 to 7 of the present invention) each containing Cu, Co, Si, Zn, and unavoidable impurities in a predetermined ratio were produced according to the flow chart shown in FIG. 1.

The production conditions of Example 2 were the same as those of Example 1. Note that the final cold working rate in Example 2 was 21%.

### Comparative Example 1

In Comparative Example 1, copper alloys (Comparative Products 1 to 4) each containing Cu, Co, Si, and unavoidable impurities in a composition ratio departing from a predetermined range were produced according to the flow chart shown in FIG. 1.

The production conditions of Comparative Example 1 were the same as those of Example 1. Note that the final cold working rate in Comparative Example 1 was 21%.

### Comparative Example 2

In Comparative Example 2, a copper alloy (Comparative Product 5) containing Cu, Co, Si, Zn, and unavoidable impurities in a predetermined ratio and produced by cooling at a cooling rate of 5° C./h after the aging treatment was produced according to the flow chart shown in FIG. 1.

The production conditions of Comparative Example 2 were the same as those of Example 1 except that the cooling rate after the aging treatment was changed to 5° C./h. Note that the final cold working rate in Comparative Example 2 was 21%.

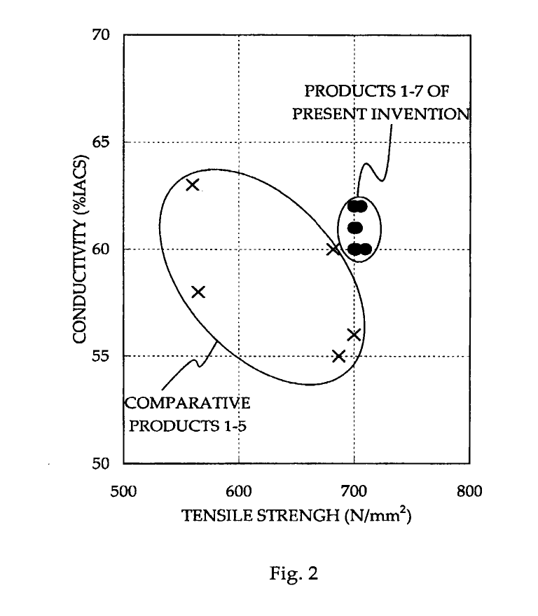

Table 1 shows evaluation results of the tensile strength, conductivity, and plating adhesion of the copper alloys obtained in Examples 1 and 2 and Comparative Examples 1 and 2. FIG. 2 shows a relationship between the tensile strength and conductivity of the copper alloys.

TABLE 1

| | | | | | | Cooling | | | | | |
|---|---|---|---|---|---|---|---|---|---|---|---|
| | | Composition | | | | rate | Inclusion | Maximum | Tensile | | |
| | Sample | (mass %) | | | | after aging | volume ratio | inclusion size | strength | Conductivity | Plating |
| Kind | number | Co | Si | Zn | Co/Si | (° C./h) | (%) | (μm) | (N/mm²) | (% IACS) | adhesion |
| Present | 1 | 0.81 | 0.17 | | 4.8 | 30 | 0.4 | 0.6 | 700 | 62 | Δ |
| invention | 2 | 1.24 | 0.29 | | 4.3 | 30 | 0.3 | 0.5 | 702 | 61 | ◯ |
| product | 3 | 1.78 | 0.58 | | 3.1 | 10 | 0.5 | 0.6 | 710 | 60 | Δ |
| | 4 | 1.28 | 0.29 | 0.5 | 4.4 | 30 | 0.4 | 0.5 | 700 | 61 | ◯ |
| | 5 | 1.24 | 0.28 | 1.0 | 4.3 | 30 | 0.4 | 0.5 | 702 | 60 | ◯ |
| | 6 | 1.28 | 0.29 | 0.5 | 4.4 | 10 | 0.4 | 0.6 | 706 | 62 | ◯ |
| | 7 | 1.28 | 0.29 | 0.5 | 4.4 | 50 | 0.4 | 0.5 | 700 | 60 | ◯ |
| Comparative | 1 | 0.60 | 0.55 | | 1.1 | 30 | 0.4 | 0.5 | 565 | 58 | ◯ |
| Example | 2 | 2.00 | 0.60 | | 3.3 | 30 | 0.8 | 2.5 | 687 | 55 | X |
| | 3 | 0.80 | 0.14 | | 5.7 | 30 | 0.3 | 0.5 | 560 | 63 | ◯ |
| | 4 | 1.80 | 0.75 | | 2.4 | 30 | 0.8 | 0.5 | 700 | 56 | Δ |
| | 5 | 1.28 | 0.29 | 0.5 | 4.4 | 5 | 0.7 | 4.5 | 682 | 60 | Δ |

Table 1 and FIG. 2 reveal that the copper alloys of Products 1 to 7 of the present invention each had a maximum inclusion size of 2 μm or less, a volume ratio of the inclusion of 0.5 vol % or less, a tensile strength of 700 N/mm² or more, and a conductivity of 60% IACS or more.

The copper alloy of Product 2 of the present invention had favorable plating adhesion even though the alloy contained no Zn. Note that in the copper alloys of Products 1 to 3 of the present invention, plated films did not peel off.

The copper alloys of Products 4 to 7 of the present invention each contained Zn and thus had favorable plating adhesion.

Meanwhile, the copper alloys of Comparative Products 1 and 3 each had insufficient amounts of Co or Si. Thus, a sufficient amount of Co₂Si compound was not precipitated, and desired tensile strength was not obtained.

The copper alloy of Comparative Product 2 had too great an amount of Co. An undesired compound phase was formed due to excess Co, and the amount and size of inclusions increased. Thus, desired strength and conductivity were not obtained and plating adhesion was poor. Similarly, the copper alloy of Comparative Product 4 had too great an amount of Si. An undesired compound phase was formed due to excess Si, and desired conductivity was not obtained.

The copper alloy of Comparative Product 5 had too slow a cooling rate after the aging treatment. The maximum size of inclusions increased to 4.5 μm and the volume ratio thereof increased to 0.7%. Thus, desired tensile strength was not obtained.

### Example 3

In Example 3, copper alloys (Products 8 to 38 of the present invention) each containing Cu, Co, Si, Zn, and unavoidable impurities and one or more elements selected from the group consisting of Fe, Ni, P, Sn, Mg, Zr, Cr, and Mn in a predetermined ratio were produced following the flow chart shown in FIG. 1. The production conditions of Example 3 were the same as those of Example 1 except that the composition ratio shown in Table 2 was used and the cooling rate was changed to 30° C./h. Note that the final cold working rate in Example 3 was 21%.

Table 2 shows the evaluation results of the tensile strength, conductivity, plating adhesion, and bending workability of the copper alloys obtained in Example 3.

TABLE 2

| | Sample | Composition (mass %) | | | | | | | | | | | |
|---|---|---|---|---|---|---|---|---|---|---|---|---|---|
| Kind | number | Co | Si | Zn | Fe | Ni | P | Sn | Mg | Zr | Cr | Mn | Co/Si |
| Present | 8 | 1.24 | 0.29 | 0.5 | 0.007 | | | | | | | | 4.3 |
| invention | 9 | 1.24 | 0.30 | 0.5 | 0.01 | | | | | | | | 4.1 |
| product | 10 | 1.27 | 0.29 | 0.5 | 0.2 | | | | | | | | 4.4 |
| | 11 | 1.24 | 0.28 | 0.5 | | 0.006 | | | | | | | 4.4 |
| | 12 | 1.24 | 0.29 | 0.5 | | 0.01 | | | | | | | 4.3 |
| | 13 | 1.24 | 0.30 | 0.5 | | 0.2 | | | | | | | 4.1 |
| | 14 | 1.25 | 0.29 | 0.5 | | | 0.006 | | | | | | 4.3 |
| | 15 | 1.25 | 0.30 | 0.5 | | | 0.01 | | | | | | 4.2 |
| | 16 | 1.24 | 0.29 | 0.5 | | | 0.2 | | | | | | 4.3 |
| | 17 | 1.24 | 0.27 | 0.5 | | | | 0.008 | | | | | 4.6 |
| | 18 | 1.27 | 0.28 | 0.5 | | | | 0.01 | | | | | 4.5 |
| | 19 | 1.23 | 0.28 | 0.5 | | | | 0.2 | | | | | 4.4 |
| | 20 | 1.26 | 0.29 | 0.5 | | | | | 0.006 | | | | 4.3 |
| | 21 | 1.24 | 0.29 | 0.5 | | | | | 0.01 | | | | 4.3 |
| | 22 | 1.24 | 0.30 | 0.5 | | | | | 0.2 | | | | 4.1 |
| | 23 | 1.24 | 0.30 | 0.5 | | | | | | 0.006 | | | 4.1 |
| | 24 | 1.26 | 0.30 | 0.5 | | | | | | 0.01 | | | 4.2 |
| | 25 | 1.26 | 0.27 | 0.5 | | | | | | 0.2 | | | 4.7 |
| | 26 | 1.23 | 0.31 | 0.5 | | | | | | | 0.006 | | 4.0 |
| | 27 | 1.29 | 0.31 | 0.5 | | | | | | | 0.01 | | 4.2 |
| | 28 | 1.24 | 0.30 | 0.5 | | | | | | | 0.2 | | 4.1 |
| | 29 | 1.23 | 0.27 | 0.5 | | | | | | | | 0.007 | 4.6 |
| | 30 | 1.25 | 0.30 | 0.5 | | | | | | | | 0.01 | 4.2 |
| | 31 | 1.25 | 0.28 | 0.5 | | | | | | | | 0.2 | 4.5 |
| | 32 | 1.25 | 0.29 | 0.5 | 0.15 | | 0.05 | | | | | | 4.3 |
| | 33 | 1.24 | 0.29 | 0.5 | | 0.1 | 0.05 | | | | | | 4.3 |
| | 34 | 1.27 | 0.29 | 0.5 | | | | 0.1 | 0.05 | | | | 4.4 |
| | 35 | 1.26 | 0.27 | 0.5 | | | | | | 0.1 | 0.1 | | 4.7 |
| | 36 | 1.26 | 0.28 | 0.5 | | | | 0.1 | 0.05 | 0.05 | | | 4.5 |
| | 37 | 1.26 | 0.28 | 0.5 | | 0.1 | 0.05 | | | | | 0.05 | 4.5 |
| | 38 | 1.24 | 0.29 | 0.5 | | 0.1 | | | | 0.05 | | 0.05 | 4.3 |

| | | Inclusion | Maximum | | | | |
|---|---|---|---|---|---|---|---|
| | | Volume | inclusion | Tensile | | | |
| | Sample | ratio | size | strength | Conductivity | Plating | Bending |
| Kind | number | (%) | (μm) | (N/mm²) | (% IACS) | adhesion | workability |
| Present | 8 | 0.4 | 0.5 | 700 | 60 | ◯ | B |
| invention | 9 | 0.4 | 0.5 | 703 | 61 | ◯ | A |
| product | 10 | 0.4 | 0.5 | 710 | 60 | ◯ | A |
| | 11 | 0.4 | 0.5 | 701 | 60 | ◯ | B |
| | 12 | 0.4 | 0.5 | 704 | 61 | ◯ | A |
| | 13 | 0.4 | 0.5 | 712 | 60 | ◯ | A |
| | 14 | 0.4 | 0.5 | 701 | 60 | ◯ | B |
| | 15 | 0.4 | 0.5 | 705 | 61 | ◯ | B |
| | 16 | 0.4 | 0.5 | 711 | 60 | ◯ | B |
| | 17 | 0.4 | 0.5 | 700 | 60 | ◯ | B |
| | 18 | 0.4 | 0.5 | 705 | 60 | ◯ | B |
| | 19 | 0.4 | 0.5 | 713 | 60 | ◯ | B |
| | 20 | 0.4 | 0.5 | 700 | 60 | ◯ | B |
| | 21 | 0.4 | 0.5 | 704 | 61 | ◯ | B |
| | 22 | 0.4 | 0.5 | 712 | 60 | ◯ | B |
| | 23 | 0.4 | 0.5 | 701 | 60 | ◯ | B |
| | 24 | 0.4 | 0.5 | 703 | 60 | ◯ | B |
| | 25 | 0.4 | 0.5 | 710 | 60 | ◯ | B |
| | 26 | 0.4 | 0.5 | 700 | 60 | ◯ | B |
| | 27 | 0.4 | 0.5 | 705 | 60 | ◯ | B |
| | 28 | 0.4 | 0.5 | 715 | 60 | ◯ | B |
| | 29 | 0.4 | 0.5 | 700 | 60 | ◯ | B |
| | 30 | 0.4 | 0.5 | 703 | 61 | ◯ | B |
| | 31 | 0.4 | 0.5 | 713 | 60 | ◯ | B |
| | 32 | 0.4 | 0.5 | 714 | 60 | ◯ | A |
| | 33 | 0.4 | 0.5 | 710 | 60 | ◯ | A |
| | 34 | 0.4 | 0.5 | 712 | 60 | ◯ | B |
| | 35 | 0.4 | 0.5 | 712 | 61 | ◯ | B |
| | 36 | 0.4 | 0.5 | 715 | 60 | ◯ | B |
| | 37 | 0.4 | 0.5 | 711 | 60 | ◯ | A |
| | 38 | 0.4 | 0.5 | 710 | 60 | ◯ | A |

Table 2 reveals that the copper alloys of Products 8 to 38 of the present invention each had a maximum inclusion size of 2 μm or less, an inclusion volume ratio of 0.5 vol % or less, a tensile strength of 700 N/mm² or more, and a conductivity of 60% IACS or more.

The copper alloys of Products 8 to 38 of the present invention each contained Zn and thus had favorable plating adhesion.

The copper alloys of Products 9-10, 12-13, 32-33 and 37-38 of the present invention each had fine crystal grains through addition of a predetermined amount of Fe or Ni, and thus had excellent bending workability.

### Example 4

In Example 4, a copper alloy (Product 39 of the present invention) containing Cu, Co, Si, and unavoidable impurities in a predetermined ratio and having an O₂ content of 10 ppm or less and an H₂ content of 1 ppm or less, a copper alloy (Product 40 of the present invention) containing Cu, Co, Si, and unavoidable impurities in a predetermined ratio and having an O₂ content of more than 10 ppm and an H₂ content of 1 ppm or less, and a copper alloy (Product 41 of the present invention) containing Cu, Co, Si, and unavoidable impurities in a predetermined ratio and having an O₂ content of more than 10 ppm and an H₂ content of more than 1 ppm were produced according to the flow chart shown in FIG. 1. The production conditions of Product 39 of the present invention were the same as those of Example 1 except that degassing was conducted by blowing an Ar gas into a molten liquid containing melted raw materials. The production conditions of Products 40 and 41 of the present invention were the same as those of Example 1. Note that the final cold working rate in Example 4 was 21%.

Table 3 shows the evaluation results of the tensile strength, conductivity, plating adhesion, and soldering properties of the copper alloys obtained in Example 4.

TABLE 3

| | | | | | | | Cooling | In- | | | | | | |
|---|---|---|---|---|---|---|---|---|---|---|---|---|---|---|
| | | | | | | | rate | clusion | Maximum | | | Plating | | |
| | | Composition | | | | | after | volume | inclusion | Tensile | Conduct- | adhesion | | Sold- |
| | Sample | Co | Si | | O₂ | H₂ | aging | ratio | size | strength | ivity | 500 | 1000 | ering |
| Kind | number | (mass %) | (mass %) | Co/Si | (ppm) | (ppm) | (° C./h) | (%) | (μm) | (N/mm²) | (% IACS) | hours | hours | property |
| Present | 39 | 1.28 | 0.30 | 4.3 | 9 | 0.3 | 30 | 0.4 | 0.5 | 702 | 61 | ◯ | ◯ | ◯ |
| invention | 40 | 1.30 | 0.31 | 4.2 | 20 | 0.3 | 30 | 0.4 | 0.5 | 701 | 60 | ◯ | Δ | Δ |
| product | 41 | 1.27 | 0.29 | 4.4 | 50 | 5 | 30 | 0.4 | 0.5 | 700 | 60 | Δ | X | Δ |

Table 3 reveals that the copper alloys of Products 39 to 41 of the present invention each had a maximum inclusion size of 2 μm or less, an inclusion volume ratio of 0.5 vol % or less, a tensile strength of 700 N/mm² or more, and a conductivity of 60% IACS or more. The copper alloy of Product 39 of the present invention had excellent plating adhesion and soldering properties after 500 hours and 1,000 hours. The results indicated that the plating adhesion and soldering properties improve by adjusting the O₂ content to 10 ppm or less and the H₂ content to 1 ppm or less in the copper alloy.

As described above, the copper alloy of the present invention has excellent strength and conductivity, that is, a tensile strength of 700 N/mm² or more, and a conductivity of 60% IACS or more. Further, the method of producing a copper alloy of the present invention allows production of a copper alloy having a tensile strength of 700 N/mm² or more and a conductivity of 60% IACS or more.

1-8. (canceled)

9. A copper alloy consisting of from 0.8 mass % to 1.8 mass % of Co, from 0.16 mass % to 0.6 mass % of Si, and the balance of Cu and unavoidable impurities, wherein
a mass ratio of Co to Si (Co/Si) is between 3.0 and 5.0;
a size of inclusions to be precipitated in the copper alloy is 2 μm or less; and
a total volume of the inclusions having a size of between 0.05 μm and 2 μm in the copper alloy is from 0.3 vol % to 0.5 vol %.

10. The copper alloy according to claim 9, wherein the copper alloy has an O₂ content of 10 ppm or less and an H₂ content of 1 ppm or less.

11. The copper alloy according to claim 9, wherein a Co content is from 0.81 mass % to 1.78 mass %, a Si content is 0.17 mass % to 0.58 mass %, and a Co/Si ratio is 3.1 to 4.8.

12. A copper alloy consisting of from 0.8 mass % to 1.8 mass % of Co, from 0.16 mass % to 0.6 mass % of Si, from 0.1 mass % to 1.0 mass % of Zn and the balance of Cu and unavoidable impurities, wherein
a mass ratio of Co to Si(Co/Si) is between 3.0 and 5.0;
a size of inclusions to be precipitated in the copper alloy is 2 μm or less; and
a total volume of the inclusions having a size of between 0.05 μm and 2 μm in the copper alloy is from 0.3 vol % to 0.5 vol %.

13. The copper alloy according to claim 12, wherein the copper alloy has an O₂ content of 10 ppm or less and an H₂ content of 1 ppm or less.

14. A copper alloy comprising from 0.8 mass % to 1.8 mass % of Co, from 0.16 mass % to 0.6 mass % of Si, and the balance of Cu and unavoidable impurities, wherein
a mass ratio of Co to Si(Co/Si) is between 3.0 and 5.0;
a size of inclusions to be precipitated in the copper alloy is 2 μm or less; and
a total volume of the inclusions having a size of between 0.05 μm and 2 μm in the copper alloy is from 0.3 vol % to 0.5 vol %; and
having a conductivity of 60% IACS or more and a tensile strength of 700 N/mm² or more.

15. The copper alloy according to claim 14, comprising from 0.1 mass % to 1.0 mass % of Zn.

16. The copper alloy according to claim 14, comprising from 0.01 mass % to 0.2 mass % of one or more elements selected from the group of Fe, Ni, P, Sn, Mg, Zr, Cr and Mn in total.

17. The copper alloy according to claim 14, wherein a tensile strength is 700 N/mm² to 710 N/mm².

18. The copper alloy according to claim 14, wherein a conductivity is 60% IACS to 62% IACS.

19. The copper alloy according to claim 14, wherein the copper alloy has an O₂ content of 10 ppm or less and an H₂ content of 1 ppm or less.
